(19) United States
(12) Patent Application Publication
(10) Pub. No.: US 2023/0357641 A1
(43) Pub. Date: Nov. 9, 2023

(54) FLUIDISED BED PYROLYSIS APPARATUS AND METHOD

(71) Applicant: UNIVERSITY OF PRETORIA, Pretoria (ZA)

(72) Inventors: Michael David HEYDENRYCH, Centurion (ZA); Ryan David MERCKEL, Centurion (ZA)

(21) Appl. No.: 18/025,931

(22) PCT Filed: Sep. 14, 2020
(86) PCT No.: PCT/ZA2020/050047

§ 371 Date: Mar. 13, 2023

(51) Int. Cl. C10B 49/22; C10B 57/06; C10B 57/00; C10J 3/56; C10J 3/54

(52) U.S. Cl. CPC C10B 49/22; C10B 57/06; C10B 57/005; C10J 3/56; C10J 3/54; C10J 2200/09; C10J 2300/1807; C10J 2300/1207

(57) ABSTRACT

The invention provides a carbonaceous feed pyrolysis apparatus including two or more hot particle fluidised beds, and material transfer means for the transfer of hot catalyst particles between two or more of the beds, wherein one or more of the 5 fluidised beds is a gasifier which contains a gasification zone and one or more of the fluidised beds is a pyrolysis reactor which contains a pyrolysis zone, so that the particles are recirculated and serve as an energy carrier to drive pyrolysis in the pyrolysis zone. The invention extends to a carbonaceous feed pyrolysis process using said apparatus.

### FIELD OF THE INVENTION

The invention relates to the pyrolysis of carbonaceous material, such as bio-mass, in a fluidised bed pyrolysis apparatus.

### BACKGROUND TO THE INVENTION

Fast pyrolysis of bio-mass involves rapidly heating solid bio-mass to a temperature of 400° C. to 600° C. in reducing conditions so that it forms an oil. This is typically done in a fluidized bed, where approximately 60% of the original bio-mass can be recovered as oil. The pyrolysis is typically endothermic in nature, and the energy required is typically obtained by heating the fluidized bed indirectly, using electrical heating elements.

In WO 2012/034141 of the present applicant, there is provided pyrolysis of a carbonaceous bio-mass, which process includes 2 or more fluidised beds, a first combustion zone carried out in one or more combustion fluidised beds in which a particulate material is fluidised and heated, and a second pyrolysis zone carried out in one or more pyrolysis fluidised beds in which the hot particles heated in the combustion zone are used for pyrolysis of the bio-mass, said combustion zone being operated at or about atmospheric pressure at a temperature of from 400° C. to 1100° C., typically around 900° C., and the pyrolysis zone being operated at a temperature of from 400° C. to 900° C.

The inventor is aware of the operation of catalyst regeneration as a combustion chamber as in catalytic pyrolysis.

The inventors have thus identified a need for a more efficient pyrolysis apparatus for the pyrolysis of bio-mass while regenerating the catalyst.

In this specification, wherever the term “gasifier” is used, unless the context clearly indicates the contrary, it refers to a reaction vessel in which carbonaceous feed material (such as char, organic liquids and/or organic vapours) reacts with oxygen and optionally steam so that substantially all oxygen is consumed in the vessel.

### SUMMARY OF THE INVENTION

According to a first aspect of the invention, there is provided a carbonaceous feed pyrolysis apparatus including two or more hot particle fluidised beds, and material transfer means for the transfer of hot catalyst particles between two or more of the beds, wherein one or more of the fluidised beds is a gasifier which contains a gasification zone and one or more of the fluidised beds is a pyrolysis reactor which contains a pyrolysis zone, so that the particles are recirculated and serve as an energy carrier to drive pyrolysis in the pyrolysis zone.

The material transfer means may be one or more positive displacement apparatus.

The particles may be sand, catalyst, char, two or more of the aforementioned, or the like.

The positive displacement apparatus may be a screw feeder or the like.

The screw feeder may be driven by a variable speed drive motor or a constant speed drive motor.

In use, bio-mass is fed to the pyrolysis apparatus by bio-mass feeding means at one or more of the fluidised beds.

The apparatus as described above, may include a partial condenser and a recycle duct for recycling non-condensable gas produced in the pyrolysis zone back to the pyrolysis zone thereby creating a recirculation pyrolysis gas loop. The apparatus includes purge means whereby some non-condensable gas is produced in this loop. The purge may be fed to the gasifier or burnt in a combustor.

The flow rate of the aforesaid purge is controlled in relation to the amount of bio-mass that is introduced into the pyrolysis zone. This in turn determines the flow of gas between the gasification zone and the pyrolysis zone at the location where particles move from the gasification zone to the pyrolysis zone. This location is typically at the top of the fluidised beds, where particles overflow from the gasification zone to the pyrolysis zone, but may also be from the top of the gasification zone to the bottom of the pyrolysis zone.

The gas exiting the gasification zone is substantially devoid of oxygen, and therefore by increasing the regulated flow of gas in the aforementioned purge, the flow of gas between the gasification zone and the pyrolysis zone is in the direction of the flow of the hot particles, from gasification zone to pyrolysis zone.

The gas that passes from the gasification zone to the pyrolysis zone contains gas species (such as CO and hydrogen) that may be beneficial to the pyrolysis process.

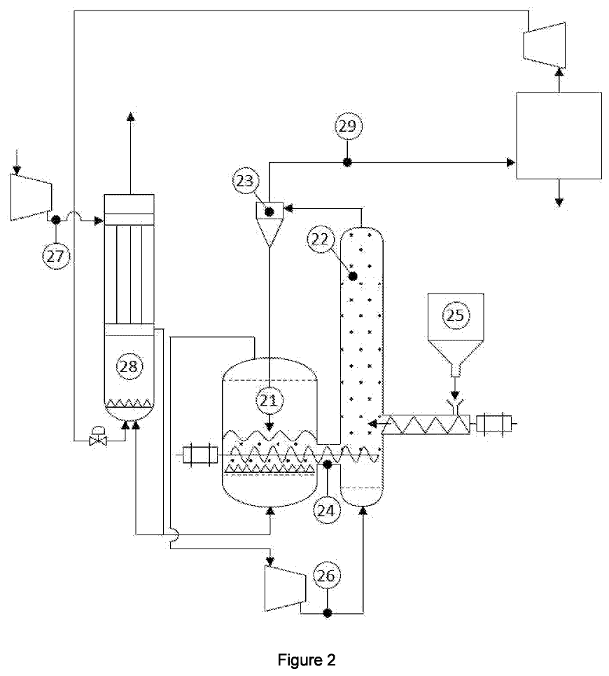

The flow of gas from the gasification zone to the pyrolysis zone may be increased until all of the gas produced in the gasification zone is directed to the pyrolysis zone. Said gas can be introduced at the bottom of the pyrolysis zone. An example of such a system is shown in FIG. 2.

Gases produced by the gasifier may be burned in a combustor that operates with excess air in order to completely combust all combustible species. Such combustible species may come from the gasifier but also from the purge of non-condensable gases from the pyrolysis gas loop.

Oxygen flow rate to the combustion zone may be adjusted in order to ensure that there is always sufficient excess oxygen in the gas exiting from the combustion zone. This may be estimated by measuring CO₂ concentration in the exit gases and inferring excess oxygen.

The combustion zone, also referred to as the combustor, may be operated substantially free of solid particles.

The hot gases produced in the combustion zone may be used to preheat oxygen by indirect heat transfer. Oxygen may be in the form of air or oxygen-enriched air. This preheated oxygen may be used in the combustion zone and/or in the gasification zone.

The hot gases from the combustion zone may be used to vaporise and superheat a liquid product from the separation processes of the pyrolysis gas loop. This product may contain water and light organic compounds. The superheated product may be burned in the combustion chamber and/or introduced into the gasifier.

Char from the pyrolysis zone may be carried over with the catalyst particles, thereby providing fuel for the gasifier.

The amount of char carry-over can be influenced by the particle size of the biomass entering the pyrolysis zone.

The apparatus may include a char separator after the pyrolysis fluidised bed whereby char can be captured. A portion of the captured char may be recycled to the gasification fluidised bed or be used for other purposes unrelated to the operation of the pyrolysis apparatus. The char separator may be a cyclone.

The apparatus may include a char extraction device that removes char directly from one of the fluidised beds.

The char extraction device may be in flow communication with an overflow zone whereby char is removed by overflow from the gasification zone.

The char extraction device may be in flow communication with a bottom zone of the gasification zone, thereby to remove char as well as clinker material that may have formed.

Char may be removed as a product from one of the fluidised beds, preferably from the gasification fluidised bed. The char may be cooled and separated from the particles of the fluidised bed, such as catalyst. The particles of the fluidised bed may consist of char alone, where separation is not necessary.

Char may be converted to activated carbon by superheated purge gas.

The catalyst in the pyrolysis zone converts CO to CO₂ to deoxygenate the fuel product, thereby improving fuel quality in order to produce fuel of at least the same calorific value as the biomass used to produce it, typically at least 35 MJ kg⁻¹.

To improve the fuel quality above 35 MJ kg⁻¹, it is necessary to convert some char to CO in the gasifier and thus some or all of the gasifier product may be directed into the pyrolysis gas loop.

The flow rate of hot particles may be controlled by means of a positive displacement apparatus such as a screw conveyor. This flow rate may be used to control the temperature of the pyrolysis bed by increasing the rotation speed of a variable speed drive in order to raise the temperature of the pyrolysis bed.

The flow rate of air to the gasification zone may be used to control the temperature of the gasification zone, but should not be increased to a flow rate whereby excess oxygen leaves the gasification zone.

The gasifier fluidised bed may include fluidised bed nozzles whereby the fluidising gas, as well as or any combustion gases, are injected into the fluidised bed through one or more nozzles at a base portion of the fluidised bed.

The pyrolysis fluidised bed may have a similar nozzle arrangement for the fluidising gas.

The superficial gas velocity (SGV) of the recycle pyrolysis gas may be as low as possible while still achieving good fluidisation and thus mixing.

The SGV in the pyrolysis fluidised bed may be from 0.2 m s⁻¹ to 2 m s⁻¹, typically 0.5 m s⁻¹. It is believed that in this way less enthalpy is lost by means of heating the cold recycle gas. The bio-mass also enters as a solid, and leaves as a gas, thereby increasing the superficial gas velocity as the pyrolysis reaction occurs. The SGV of the recycled pyrolysis gas is controlled or selected in relation to the degree of entrainment of char particles and thus if a low SGV of recycle pyrolysis gas is selected, more char can be retained in the pyrolysis fluidised bed and thus provide a greater feed of char to the gasifier.

An oxygen-free zone is present directly above the gasification zone in the gasifier so that the gasifier gaseous products which are transferred to the pyrolysis zone are substantially oxygen-free.

The fluidised beds may include disengagement zones. The pressure in the disengagement zones of both the pyrolysis and combustion fluidised beds may be close to atmospheric pressure because of the difficulty of adequate sealing at high temperatures. The pressure in the disengagement zone may be controlled by controlling the speed of an induced draft (ID) fan or by controlling a damper setting in a low-pressure line.

The pyrolysis zone and the disengagement space above it in the pyrolysis reactor may be substantially oxygen free.

Where the particles are catalyst particles, the gasifier serves to regenerate the catalyst as it, amongst other processes, burns off any coke formed in the pores of the particles during pyrolysis.

The catalyst is regenerated in the gasifier, where there is not excess oxygen, but the predominant reaction is the gasification of carbon via the latter's oxidation to CO, and therefore will still be a suitable environment to regenerate the coked catalyst.

The catalyst may be a layered double hydroxide (LDH), or a layered double oxide (LDO), or a mixed metal oxide (MMO) or spinel.

The catalyst may be an acidic catalyst such as a zeolite.

The catalyst may be immobilised in a porous catalyst support to provide mechanical strength.

### DESCRIPTION OF AN EMBODIMENT OF THE INVENTION

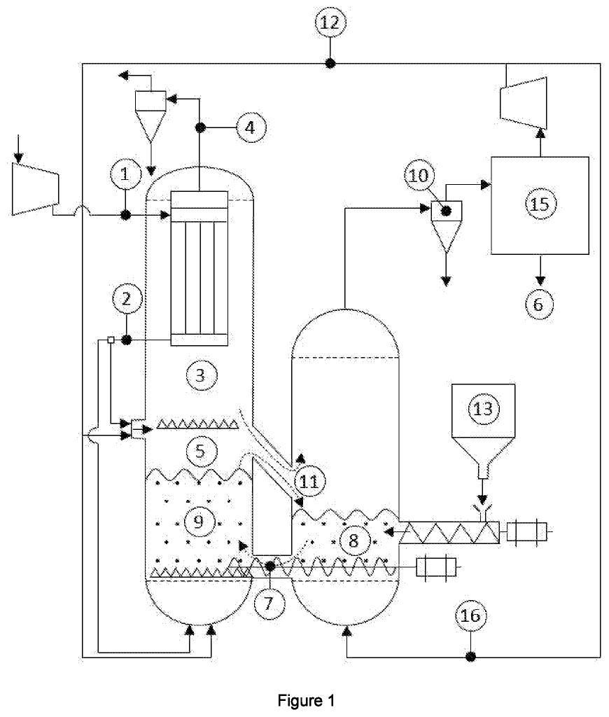

The invention will now be described, by way of non-limiting example only, with reference to the accompanying flow sheet and diagrammatic drawings, FIGS. 1 and 2.

In FIG. 1 is shown a flowsheet of a dual fluidised bed pyrolysis apparatus of the invention; and

FIG. 2 shows another embodiment of the pyrolysis apparatus of FIG. 1 with the gasifier and pyrolysis reactor in series.

In FIG. 1, gaseous feed (1) containing an oxidant, which may be pure oxygen, air enriched with oxygen or preferably pure air may be preheated by indirect heating in a combustor (3). The heated gas (2) may be split, part entering the gasifier, and part entering the combustor.

The combustor (3) is operated with an excess of oxygen to ensure complete combustion.

The flue gas (4) from the combustor (3) may be used to dry biomass feedstock (13).

The amount of preheated gas (2) entering the gasifier (9) is regulated so that there is negligible oxygen present in the gasifier (9) freeboard (5).

The temperature of stream (6) may be chosen so that water and more volatile organic compounds are not condensed and are returned in the vapour phase to the pyrolysis zone (8), gasification zone (9) and combustor (3) in a suitable split.

The gasifier (9) and the pyrolysis reactor (8) are bubbling fluidised beds.

The fluidised bed particles may have a catalytic effect on the reactions that occur in the gasifier (9) and/or the pyrolysis reactor (8).

Carbonaceous material present with fluidised bed particles may participate in reactions or have a catalytic effect on reactions that occur in the gasifier (9) and/or the pyrolysis zone (pyrolysis reactor) (8).

Biomass is fed into the pyrolysis reactor (8) and when required, to the gasifier (9) to supply the energy requirements of the gasifier (9).

Screw conveyor (7) is driven by a variable speed drive to move solid material from the pyrolysis fluidised bed (8) to the gasifier fluidised bed (9). Solids flow over an aperture (11) from the gasifier fluidised bed to the pyrolysis fluidised bed (8). The rate of stream (12) is controlled in order to control the flow of gas from the gasifier freeboard (5) through the aperture (11) to a recirculation pyrolysis gas loop (16) above the bed of the pyrolysis reactor (8).

The solids separator (10) may be contained within the said single vessel in either or both reactors.

The pyrolysis reactor operates in a temperature range of 300° C. to 600° C., preferably 500° C.

The gasifier (9) operates at 550° C. to 1000° C., preferably 750° C.

The pyrolysis reactor/gasifier operate at substantially the same pressure, with the pressure equal at the aperture (11). If the pyrolysis reactor and gasifier are contained in the same vessel, said vessel may operate at a system pressure between 80 kPa and 2000 kPa, preferably at atmospheric pressure +2 kPa.

The biomass feed (13) may be metered from a multitude of feed hoppers operated at the system pressure, with a positive displacement device used to meter the flow of the biomass feed. Such feed hoppers may be singularly depressurised by releasing the gas into the combustion chamber, refilled with biomass, and re-pressurised by using gas from stream (12). During the re-pressurisation step, air may be displaced by releasing such air into the combustion chamber (3).

The process is designed to primarily produce pyrolysis-oil, such as bio-oil, but may be operated to produce bio-oil and char or to produce bio-oil and combustible gas (12) depending on market requirements.

Gas leaving the char cyclone (10) is cooled in multiple cyclones with indirect cooling through the cyclone walls. Condensed bio-oil product is collected at various suitable condensation temperatures, followed by an electrostatic precipitator.

FIG. 2 shows the apparatus and process wherein catalyst circulates between the bubbling bed gasifier (21), the circulating fluidised bed pyrolysis riser (22) and the separation cyclone (23) as stream (29). The screw conveyor (24) regulates the flow of the recirculating catalyst. Biomass enters the pyrolysis reactor through a positive displacement regulating device (25).

Air entering at stream 27 is preheated in a combustion chamber 28, and substantially all oxygen is consumed in the gasifier 21. The hot CO-containing gas in stream 26 transports solid particles through the riser (22), where pyrolysis occurs. The hot gases containing bio-oil exit the cyclone 23 and are cooled by a multitude of cyclones with indirect cooling through the walls of the abovementioned cyclones, which also separated the condensed bio-oil.

An electrostatic precipitator removes the last traces of bio-oil.

In both embodiments (FIGS. 1 and 2), the additional CO in the pyrolysis zone assists in deoxygenating the fuel product, thereby improving fuel quality in order to produce fuel of at least 35 MJ kg⁻¹. To improve the fuel quality above 35 MJ kg⁻¹, it is necessary to convert some char to CO in the gasifier and thus some or all of the gasifier product may be directed into the pyrolysis gas loop.

A mass and energy balance over a process described in FIG. 1 was simulated to illustrate the viability of a non-limiting instance of the invention. 3000 kg h⁻¹ of biomass (dry basis) with an H/C molar ratio of 1.31, O/C molar ratio of 0.69 and moisture content of 9.2% was fed (13) to the pyrolysis reactor (8). In the pyrolysis reaction, 13.6% of the biomass was converted to char, and 45% of this char was retained in the bed and served as fuel to the gasifier (9). 3300 kg h⁻¹ of air (1) was preheated by indirect heat exchange within the combustor zone (3) to a temperature of 750° C. (stream 2), and of this preheated air, 1813 kg h⁻¹ was introduced into the gasifier (9). This resulted in a gas composition above the gasifier bed at point (5) of 7% CO, 16.8% CO₂ and the remainder nitrogen. The remainder of the preheated air was introduced into the combustor (3) in order to combust both the gas produced in the gasifier (5) and the purge of the non-condensable gas stream (stream 12) at a temperature of 950° C. The flue gas (4) contained 4.7% excess oxygen, at a temperature of 492° C.

The catalyst was recirculated at a rate of 13 680 kg h⁻¹ between the pyrolysis bed (8) and the gasifier bed (9), thereby transferring 1 265 kW of thermal energy between the two beds. There was an assumed heat loss of 20 kW from each of the pyrolysis, gasification and combustion zones.

In the separation zone (15), it was assumed that the product oil was perfectly separated from the water. This resulted in 797 kg h⁻¹ of water, and 923 kg h⁻¹ of dry pyrolysis oil with an H/C molar ratio of 1.54, O/C molar ratio of 0.067 and a higher heating value (HHV) of 40.0 MJ kg⁻¹.

The overall efficiency of converting biomass to products was also calculated. The HHV of the biomass on a dry basis was 17.56 MJ kg⁻¹, and the flow rate was 3000 kgh⁻¹ (dry), giving a heating potential of 14.63 MW. Similarly, the (dry) pyrolysis oil had a heating potential of 10.25 MW, and the char product had a potential heating value of 1.96 MW. The thermal efficiency of converting biomass to useful products is therefore (10.25+1.96)/14.63 =83.4%.

The claims which follow form an integral part of the disclosure of the invention and, should there be any interpretation of the claims and the disclosure hereinbefore which results in a discrepancy then the claims take precedence.

1-64. (canceled)

65. A carbonaceous feed pyrolysis apparatus including two or more hot particle fluidised beds, and material transfer means for the transfer of hot catalyst particles between two or more of the beds, wherein one or more of the fluidised beds is a gasifier which contains a gasification zone and one or more of the fluidised beds is a pyrolysis reactor which contains a pyrolysis zone, so that the particles are recirculated and serve as an energy carrier to drive pyrolysis in the pyrolysis zone, which includes a char extraction device that removes char by overflow from the gasification zone.

66. A carbonaceous feed pyrolysis apparatus as claimed in claim 65, which includes a partial condenser and a recycle duct for recycling non-condensable gas produced in the pyrolysis zone back to the pyrolysis zone thereby creating a recirculation pyrolysis gas loop.

67. A carbonaceous feed pyrolysis apparatus as claimed in claim 66, which includes purge means whereby some non-condensable gas which is produced in this loop is purged and fed to the gasifier or burnt in a combustor.

68. A carbonaceous feed pyrolysis apparatus as claimed in claim 67, which includes a flow rate control means whereby the flow rate of the purge is controlled in relation to the amount of biomass that is introduced into the pyrolysis zone which in turn determines the flow of gas between the gasification zone and the pyrolysis zone at the location where particles move from the gasification zone to the pyrolysis zone.

69. A carbonaceous feed pyrolysis apparatus as claimed in claim 65, which includes a char extraction device that removes char directly from one of the fluidised beds.

70. A carbonaceous feed pyrolysis apparatus as claimed in claim 65, which includes a char separator, wherein the char separator is in flow communication with the pyrolysis gas loop thereby to convert some char to CO in the gasifier.

71. A carbonaceous feed pyrolysis process including
two or more hot particle fluidised beds wherein hot particles are transferred between two or more of the beds, wherein one or more of the fluidised beds is a gasifier which contains a gasification zone and one or more of the fluidised beds is a pyrolysis reactor which contains a pyrolysis zone;
recirculating the particles so as to serve as an energy carrier to drive pyrolysis in the pyrolysis zone;
purging some non-condensable gas which is produced in the recirculation pyrolysis gas loop and feeding purged gas to the gasifier or burning it in a combustor;
controlling the flow rate of the purged gas in relation to the amount of biomass that is introduced into the pyrolysis zone which in turn determines the flow of gas between the gasification zone and the pyrolysis zone at the location where particles move from the gasification zone to the pyrolysis zone;
burning the gas produced by the gasifier in a combustion zone that operates with excess air in order to completely combust all combustible species;
adjusting oxygen flow rate to the combustion zone so that there is excess oxygen in the gas exiting the combustion zone; and
estimating the oxygen flow rate by measuring CO₂ concentration in the gas exiting the combustion zone thereby inferring excess oxygen.

72. A carbonaceous feed pyrolysis process as claimed in claim 71, wherein the particles are selected from the group including sand, catalyst, char, and two or more of the aforementioned.

73. A carbonaceous feed pyrolysis process as claimed in claim 71, which includes partially condensing pyrolysis zone gas and recycling non-condensable gas produced in the pyrolysis zone back to the pyrolysis zone thereby creating a recirculation pyrolysis gas loop.

74. A carbonaceous feed pyrolysis process as claimed in claim 71, which includes separating out char which is formed during the pyrolysis process after the pyrolysis fluidised bed whereby char is captured.

75. A carbonaceous feed pyrolysis process as claimed in claim 74, wherein the char is fed into the pyrolysis gas thereby to convert some char to CO in the gasifier.

76. A carbonaceous feed pyrolysis process as claimed in claim 71, wherein the gas exiting the gasification zone is substantially devoid of oxygen, and by increasing the regulated flow of gas in the aforementioned purge, the flow of gas between the gasification zone and the pyrolysis zone is in the direction of the flow of the hot particles, from gasification zone to pyrolysis zone.

77. A carbonaceous feed pyrolysis process as claimed in claims 71, wherein the gas produced in the combustion zone is used to preheat oxygen by indirect heat transfer, said preheated oxygen is used in one or more of the combustion zone and the gasification zone.

78. A carbonaceous feed pyrolysis process as claimed in claim 71, wherein a catalyst in the pyrolysis zone converts CO to CO₂ to deoxygenate a fuel product produced by the process, thereby improving fuel quality in order to produce fuel of at least the same calorific value as the biomass used to produce it.

79. A carbonaceous feed pyrolysis process as claimed in claim 78, wherein flow rate of air to the gasification zone is used to control gasification zone temperature, but below a flow rate whereby excess oxygen leaves the gasification zone.

80. A carbonaceous feed pyrolysis process as claimed in claim 71, wherein superficial gas velocity (SGV) in the pyrolysis zone is from 0.2 m s⁻¹ to 2 m s⁻¹, and the SGV of the recycled pyrolysis gas is controlled or selected in relation to the degree of entrainment of char particles so that where a low SGV of recycle pyrolysis gas is selected, more char is retained in the pyrolysis zone thereby providing a greater feed of char to the gasifier.

81. A carbonaceous feed pyrolysis process as claimed in claim 71, wherein an oxygen free zone is present directly above the gasification zone in the gasifier so that the gasifier gaseous products which are transferred to the pyrolysis zone are substantially oxygen free.

82. A carbonaceous feed pyrolysis process as claimed in claim 71, wherein the fluidised beds include disengagement zones, wherein pressure in the disengagement zones of both the pyrolysis and combustion fluidised beds are close to atmospheric pressure, and the pyrolysis zone and the disengagement zone above it in the pyrolysis reactor are substantially oxygen free.

83. A carbonaceous feed pyrolysis process as claimed in claim 78, wherein where the particles are catalyst particles, the gasifier serves to regenerate the catalyst as it burns off any coke formed in the pores of the particles during pyrolysis.

84. A carbonaceous feed pyrolysis process as claimed in claim 78, wherein the catalyst is one or more of a layered double hydroxide (LDH), a layered double oxide (LDO), a mixed metal oxide (MMO), and spinel.
